(19) United States
(12) Patent Application Publication
(10) Pub. No.: US 2013/0325735 A1
(43) Pub. Date: Dec. 5, 2013

(54) Methods for Providing Unique Employee Benefits in Partnership with a Service Provider and System Therefor

(71) Applicant: Holly Bellmund, Chicago, IL (US)

(72) Inventor: Holly Bellmund, Chicago, IL (US)

(21) Appl. No.: 13/899,509

(22) Filed: May 21, 2013

Related U.S. Application Data
(60) Provisional application No. 61/649,990, filed on May 22, 2012.

(51) Int. Cl. G06Q 10/10

(52) U.S. Cl. CPC G06Q 10/1057
USPC 705/322

(57) ABSTRACT

A method and system to provide benefits to employees or other users associated with an organization, where the benefits are discounted goods and services is described. The system may involve a benefits provider that coordinates the program. The system may be effected by various computer networks involving databases.

### CROSS-REFERENCE TO RELATED APPLICATION

This application claims the benefit of U.S. Provisional Application No. 61/649,990, filed May 22, 2012.

### FIELD OF THE INVENTION

The present invention relates to methods for providing employee benefits and for marketing services, such as travel services, including the linking of these methods by partnered employers, benefit providers, and service providers. The present invention also relates to computer networks and other systems to effect these methods.

### BACKGROUND

While an employee's business travel is typically reimbursed by his or her employer, many employed individuals also commonly incur out-of-pocket expenses for personal travel. This includes the cost to fly to vacation destinations and the locations of family and friends. Like other expenses, individuals who are employed by an employer typically desire to reduce their travel expenses.

Many employers in the United States and around the world offer their employees opt-in benefits such as medical and dental insurance. Such benefits are typically offered as a tool to recruit and retain employee talent so that the employer may be productive and succeed. Indeed, during the recruitment process, a prospective employee will invariably ask “what is the benefit package?” Accordingly, the benefits package offered by an employer is a key component in attracting and retaining employees from a talent pool that is competitively shared with other employers.

In addition to attracting and retaining talented employees, the employer's benefits package is typically seen as increasing employee morale and productivity. Indeed, when a company provides a unique benefit that other companies do not, that may be a significant boost to morale. While employers strive to provide good benefits packages, they also typically seek to reduce the cost thereof. Indeed, the cost of employee benefits can be a disproportionately large portion of an employer's overall costs.

While various employee benefits have been provided by employers, such benefits have typically not included a means for the employee to buy services, such as travel services like air travel, especially at a reduced price. Accordingly, there is a need for such a benefit. There is also a need for a method and system to provide such a benefit at a cost that is reasonable to the employer.

Travel service providers, such as airline carriers, generally seek to obtain as many customers as they can, and then foster repeat business through offerings such as frequent flyer programs and/or other discounts. In this manner, travel service providers may increase their market share and profits. And with the continued success of repeat business, such travel service providers may better forecast what their potential revenue could be based on the assumption that a certain amount of their customers will continue to travel with that travel provider.

However, during difficult economic times, travel service providers may have a hard time attracting and/or maintaining business. Accordingly, there is a need for a manner in which travel service providers may cultivate new markets. To this end, travel service providers have typically not partnered with employers in order to tap into the pool of potential travel customers who work for those employers. Accordingly, there is a need for a method and system for a travel services provider to partner with an employer to cultivate this business and foster repeat business.

Beyond the foregoing example related to travel service providers, any type of service provider is on the lookout for new markets to cultivate. Similar to travel service providers, other types of service providers have also typically not partnered with employers to tap into the market represented by the employer's employees. Accordingly, there is a need for a method and system for any type of services provider to partner with an employer to cultivate and maintain employee business.

### SUMMARY OF THE INVENTION

The present invention addresses the foregoing and other shortcomings of existing methods and systems regarding employee benefits and services, including travel services.

An aspect of the present invention regards linking a travel service provider with an employer. For example, this aspect of the invention regards a travel service provider partnering with an employer to provide an employee benefits relating to travel, including an airline partnering with an employer to provide employees with an employee benefit relating to air travel.

Another aspect of the invention regards enhancing an employer's benefits package to better recruit and retain talent from a pool that is competitively shared with other employers. In this aspect of the invention, the travel services partner may simultaneously increase market share by tapping into a new source of customers and repeat business.

In another aspect of the invention, the travel service provider agrees with an employer to contribute towards a travel benefit for the employees who choose to participate (opt-in). To this end, the travel service provider may agree to contribute certain amounts toward air or other travel by the participating employee(s). The employer may also contribute a certain amount to this benefit. Ultimately, these contributions provide a benefit to participating employees (and optionally their qualifying beneficiaries) to reduce the employee's personal travel costs.

In another aspect of the invention, the value of this employee benefit as perceived by existing and potential employees preferably creates value to the employer by providing a tool to successfully attract and retain talent from a pool that is competitively shared with other employers.

In another aspect of the invention, the amounts contributed by the travel service provider are chosen to be small enough that any realized net discounting of prices to the pool of participating employees is accompanied by an increase in market share that sufficiently increases operating profit and/or stability as to provide a net value to the partnered travel services provider.

In another aspect of the current invention, the unique employee benefit contemplated by the current invention increases employee morale and productivity.

In another aspect of the invention, the service provider, such as a travel service provider, may provide an incentive for employers to partner by providing the employer with a discount on their service, e.g., business travel. This may be a significant incentive to the employer given the considerable cost of standard business travel. In this aspect of the invention, potential discounts on business travel are preferably outweighed by an increase in overall business.

Another aspect of the invention regards linking a provider (such as a service provider) with an employer (or other entity) through an intermediary such as a benefits provider. For example, a service provider and an employer may both partner with a benefits provider but not necessarily with each other. To this end, the benefits provider may manage the various components of the employee benefits program. The benefits provider may also manage relationships with various providers and employers (or other types of entities).

In another aspect of the invention, a benefits provider may provide value-added services to the service providers and employers that it may be associated with. For example, the benefits provider may provide consulting services to maximize the success of the associated benefits programs as well as data hosting services.

Another aspect of the invention regards various revenue streams for the benefits provider. For example, the benefits provider may charge fees to the other participating entities for management of the programs and/or for value-added services.

Another aspect of the present invention regards systems used to implement the foregoing. For example, computer networks, databases such as relational databases, personal digital devices such as smartphones and other devices may be used to provide this employee benefit.

### BRIEF DESCRIPTION OF THE DRAWINGS

FIG. 1 is a flowchart depicting an embodiment, pertaining to airfare, of the method of the present invention.

FIG. 2 is a flowchart showing a system architecture for an embodiment of the present invention.

FIG. 3 shows the manner in which a user, such as an employee, may interface with the system of the present invention.

FIG. 4 shows sample website features.

FIG. 5 shows a database configuration.

### DETAILED DESCRIPTION OF EMBODIMENTS

Generally, the present invention involves a method and system whereby a service provider and an employer may partner together to contribute certain amounts of funds toward the service being provided to the employer's employees. In a preferred embodiment, the service is a travel service, and more specifically, an air travel service. In this embodiment, as discussed herein, the travel service provider and employer contribute funds towards the personal travel of employees. However, it should be noted that the current invention is not limited to air travel, or even travel services in general. Instead, the current invention is applicable to many different types of services that may be provided to an employer's employees.

Referring now to the embodiment involving air travel, the employer may then offer a benefit to its employees whereby the funds contributed by the travel service provider and employer may be applied towards travel purchased by the employee. If the employee elects to opt-in to receive this benefit, the employee may have a certain percentage of his or her compensation withheld for use in purchasing travel. Later on, when the employee purchases travel, the employee's withheld compensation may be applied to the purchase along with the funds contributed by the travel service provider and employer.

In this manner, employees' travel costs may be reduced. However, the program of the present invention also creates value for the employer to offset the amount it contributes by providing the employer with the ability to offer a unique employee benefit, and by increasing employee morale and productivity. The program of the present invention also creates value for the travel service provider to offset the amount it contributes by introducing the travel service provider to a pool of potential customers that it may not otherwise access.

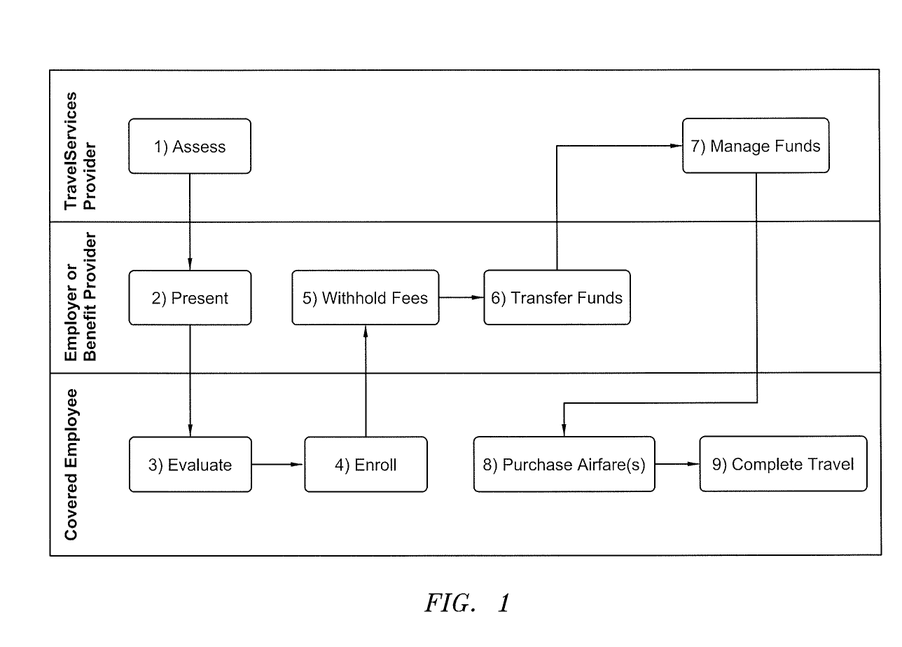

The present invention is now described with reference to FIG. 1, which generally shows a series of steps or aspects that may be used to provide the invention. As shown, the present invention may involve nine aspects or steps. Two of these aspects or steps may be associated with the travel service provider, three with the employer and four with the participating or covered employee. However, it should be noted that programs with more or fewer steps, different steps, or steps that are differently allocated between travel service provider, employer and employee are within the scope of the invention.

1) Assess (Travel Service Provider)

In this step, the travel service provider, such as an airline carrier, and the employer may generally negotiate terms for the program and their partnership. A term to be established for the program may include a covered amount which may represent the combined maximum contribution by the travel service provider and employer towards an employee's purchase of travel for a given period, e.g., a calendar year. Generally, the covered amount is used to supplement an employee's own funds towards the purchase of travel during the given period so as to reduce the employee's travel costs. However, despite the cost to the travel service provider and employer, this enables the travel service provider to tap into a new pool of customers and enables the employer to offer a unique employee benefit.

The covered amount may vary considering what travel service providers and employers are involved. For example, the covered amount established by a partnership comprising a budget airline and an employer that employs lower paid hourly workers may be relatively low. Alternatively, the covered amount established for an airline that provides high quality service and an employer that employs highly compensated professional may be relatively high. Furthermore, the covered amount may vary for a given travel service provider/employer partnership. For example, the covered amount may be higher for certain types of employees, e.g., management, while the covered amount may be lower for hourly employees. In addition, the covered amount may depend on the employee's work review ratings with a higher rated employee earning a higher covered amount compared to a lower rated employee. Accordingly, the terms to be established may include a schedule of different covered amounts depending on the particular employee at issue.

Another term to be established for the program may be the proportions of the covered amount that are contributed by each of the travel service provider and employer. For example, it may be agreed that the travel service provider and employer each contribute 50% of the covered amount. However, other proportional contributions may be used.

Another term to be established for the program may also be the contribution that is to be made by those employees who choose to opt-in and participate in this employee benefit. As further described below, the employee contribution may come in the form of a monthly amount withheld from the employee's paycheck(s), and may be set at a particular amount or within a range. The employee contribution may also vary with the type of employee at issue. For example, the withholding or other contribution made by management employees may be higher than the withholding or other contribution made by lower paid hourly workers. In any event, the employee contribution may be applied to the employee's purchase of a travel service, e.g., an airline ticket.

The difference between the covered amount and the amount contributed by the employee generally represents the reduction in travel cost incurred by the employee. That is, the plan may be established by advising the employee that if he or she contributes a certain amount of money towards the plan, he or she will receive the covered amount—which will generally be higher than the employee's contribution—to apply toward the purchase of travel.

For example, in the case where the employee is required to contribute to the program through withheld income, the required employee contribution may be $30 per month, for a total of $360 per year, and the covered amount may be $500. The difference between the covered amount and the employee's contribution for the period may represent the maximum net benefit (not adjusted for lost discounts available only through non-published fares) to the employee for the period—in this case $140.

It is preferred that the employer be responsible for ensuring that the employees who participate in the travel benefit program have the funds to provide their contribution. This is reasonable given that the travel provider typically would have no control over the finances of the employer's employees. The employer may ensure this by withholding a certain amount from each paycheck.

The terms to be established by the travel service provider and employer may also include a schedule of covered amounts and a corresponding schedule of employee contributions, depending on the employees at issue. Also, a particular travel service provider may establish this program with different employers, and a particular employer may establish this program with different travel service providers to provide different types of employee travel benefits, e.g., air travel, rental cars, hotels, vacation packages, etc.

The terms to be established for the program may also include the length of the plan period. For example, the plan period may be a calendar year. Alternatively, the plan period may comprise the amount of time between dates when employees may opt in or opt out of benefits.

The terms to be established for the program may also relate to the expiration, if any, of the benefit at the end of a given plan period. For example, the program may be established so that (i) the employee must use his or her withheld compensation to purchase travel before the end of the plan period, and (ii) if that does not occur, whatever portion of the withheld compensation that has not been used to purchase travel by the end of the period will be forfeited by the employee. In this case, the forfeited amount may be allocated, or retained, by the travel service provider and/or employer. The potential to receive such forfeited funds may provide another incentive for the travel service provider and/or employer to participate in the program of the present invention.

An example of the program of the present invention reflecting the foregoing terms to be established between a travel service provider such as an airline and employer is as follows: (i) the plan period is one year, (ii) the covered amount provided by the airline and employer is $500; (iii) the covered amount is funded by the airline and employer equally, i.e., a 50/50 split so that each partner contributes a maximum of $250 per plan year and (iv) the employee contribution is $30 withheld each month from the employee's paychecks so that the total employee contribution is $360 per year. In this example, the employee may realize a $140 reduction in his or her travel cost if he or she purchases $500 or more in travel during the plan period. At the same time, the maximum amount contributed by the airline and employer is $250, i.e., their portion of the covered amount.

For example, this example, if the employee purchased an $800 ticket, the cost of this ticket would be funded by the $500 covered amount provided by the airline and employer, and an additional $300 paid by the employee to make up the difference. But because the employee's $360 contribution accumulated over the plan year entitled that employee to receive the covered amount towards the purchase of this ticket, he or she would realize a $140 price savings. With the 50/50 split, this benefit would cost the airline and employer $70 each. However, this cost is preferably worth the value to the employer of being able to provide this employee benefit and also worth the value to the airline of obtaining this business, with the prospect of repeat business.

As another example under the same program terms, if during the plan period the employee purchased airfare totaling $400, the employee would realize a $40 price reduction, i.e., the difference between the $360 contributed and the $400 ticket. The cost to the airline and employer would only be $20 each. In this example, the employee would have forfeited $100 in price reduction, i.e., the amount between the $500 covered amount and the $400 price of purchased travel.

As another example, if the employee purchased airfare totaling $360, i.e., the amount of the employee's contribution, he or she would realize no price reduction and the airline and employer would experience no cost in providing this benefit (other than costs to administer the program).

As yet another example, where the plan requires the employee to use his or her contributed funds by the end of the plan year or forfeit those funds, but the employee purchases no travel, the airline and employer may actually profit by splitting the $360 contributed by the employee. Alternatively, if the employee purchases travel valued at less than the $360 employee contribution, the employee forfeits that difference and the airline and employer split that difference.

The airline and employer may also agree on other program terms and conditions such as requiring that only published airfares are eligible, that any amount beyond the covered amount be paid by the employee at the time of purchase (as indicated in the $800 purchase price examples above), the conditions upon which unused benefits are forfeited or reimbursed upon cessation of an employee's employment and other suitable terms. Accordingly, the present invention is not limited to the terms specifically described herein.

Another aspect of the current invention as it relates to the travel service provider relates to potential incentives that it may offer to the employer to partner into the program. For example, an airline may incentivize an employer to participate by offering discounts on the employer's business travel. This may be a significant incentive given how expensive business travel typically is. As an example, the airline may discount a certain amount on the employer's business travel for every certain number of personal travel flights that are bought by the employer's employees. The terms of any such discounting may be included in the step of the current invention where the travel service provider and employer come to terms on the parameters of the program.

2) Present (Employer and/or Travel Service Provider)

Another aspect of the employee travel benefit of the present invention involves the employer's marketing or presenting the travel benefit to its employees and/or potential employees. In this manner, the employer is preferably able to boost the morale and productivity of its current employees, and to create interest amongst potential employees when compared to other potential employers.

The employer may foster employee interest in the travel benefit program by including it as part of its overall wellness benefit package that typically includes medical, dental or other benefits. To this end, the employer may include a description of the travel benefit plan as part of its employee handbook, literature or forms that an employee typically executes when opting in for benefits. This marketing may occur before and/or during the enrollment period for employee benefits.

The marketing or presenting of the travel benefit program may include a synopsis of the program's terms and conditions. For example, the presentation of the benefit may inform employees that, if they choose to enroll, they must select an amount of money within the minimum and maximum ranges to have withheld from each pay period for the express use of purchasing travel. In one embodiment, the withheld money will go towards purchasing airfare tickets at published fares on a designated airline during the plan year. Further, the employee may also be informed if he or she chooses not to travel on the designated airline during the plan year, the benefit lapses and expires. In this embodiment, employees will not be reimbursed for failing to use this benefit during the plan year. In this embodiment, the employees may also be advised that if the employee leaves the company or is terminated during the plan year, he or she shall lose the benefit. This possible forfeiture or other non-use of employee-contributed funds may be allocated to the travel service provider, the employer or both at some predetermined split, e.g., the same split used for contributions to the covered amount. This potential windfall may be an incentive for the travel service provider and employer to participate in this travel benefit plan. Indeed, where the employer has thousands of employees, it stands to reason that some employees will not purchase travel.

Since the intent of the travel benefit program may be to provide a personal benefit to employees, the program terms marketed to the employees may also stipulate that employees can purchase airfare either: (1) only for themselves; or (2) for themselves or immediate family members; or (3) for themselves or immediate family members who are also enrolled in the employer's health insurance or other type of employer benefit. Other arrangements on covered participants may be at the discretion of the employee and employer and included within the scope of the present invention.

As shown in FIG. 1, this marketing/presentation aspect of the invention may be primarily performed by the employer. However, the travel service provider may also market the travel benefit program. For example, an airline may provide billboards or other advertisements in its airport terminals or on its website imploring travelers to inquire with their employer about providing the travel benefit. Such advertisements may also be directed to the employers. For example, an airline may market to employers about potential discounts on business travel expenses that may result from the program.

3) Evaluate (Employee)

Another aspect of the invention may involve the employee's evaluation of the services to be provided such as the travel benefit program. For example, the employee may review literature, information provided on the employer's website or other information to determine whether to enroll.

To this end, the employee may evaluate the program including, for example, the amount of money to have withheld from each pay period within the range designated by the employer. It is preferred that the employee be responsible for ensuring that he or she has accrued or will accrue sufficient vacation time during the course of the plan period to be able to take advantage of any purchased travel for personal use. To the extent available in the plan, the employee may also evaluate the contribution/plan amount (if there is a schedule of multiple contribution/plan amount levels) to contribute (preferably by automatic withholding from wages) for the express use of purchasing travel, such as airfare, through the program during the plan period.

4) Enroll (Employee)

Another aspect of the invention may involve the employee's enrollment in the travel benefit plan. For example, during an enrollment period, the employee may opt-in to the travel benefit program for the coming year, indicating the desired contribution/plan amount (if there is a schedule of multiple contribution/plan amount levels), e.g., $30 per month/$500 covered amount plan.

As part of the enrollment aspect, the employer may review and approve the employee's program application prior to the start of the plan year. For example, it is preferred that an employer ensure that an employee not sign up for too large a monthly contribution given the employee's compensation. The employer may then provide information to the travel provider on each employee who has enrolled.

The travel service provider may then issue each enrolled employee a unique identification number which may be required for travel through the program. As explained later, this unique identification number may be used to facilitate the purchase of travel and the tracking of information and success of the program.

5) Withhold Fees (Employer)

Another aspect of the current invention involves obtaining the employee contributions to the program if they are required by the terms of the program. In a preferred embodiment, at the beginning of the plan year, the employer may withhold the designated amount from each pay period, e.g., $30 each month, $50 each month or other amount. Alternatively, the employee may make a lump sum contribution.

6) Transfer Funds (Employer)

Another aspect of the current invention may involve the transfer of the employee's contribution to the travel provider. As noted earlier, an account for each employee participating in the program may be set up with the travel provider. The employee's withheld compensation may thus be transferred to the employee's account with the travel provider according to the unique identification number assigned to that employee. Within a predetermined period as agreed upon between the travel provider and the employer, the employer may transfer part or all of the withheld amount (e.g., $30 per month) to the airline's account associated with each employee's unique identification number. This predetermined time may be one of the terms agreed to during the assess step of FIG. 1.

This transfer of funds from the employer to the travel provider may represent another incentive for the travel provider to participate in the program. That is, the travel provider will have use of funds contributed by the employee and employer prior to the employee's purchase of travel. This may help with the travel provider's cash flow and operating costs. The benefit of being able to use this money may be significant where, for example, the employer has thousands of employees who enroll in the program.

In another embodiment, the employee's withheld compensation may be maintained by the employer. And at the time the airline ticket is purchased, the withheld compensation may be transferred to the airline.

7) Manage Funds (Travel Service Provider)

As shown in the manage funds step 24 of FIG. 1, another aspect of the present invention may involve the travel service provider contributing to each employee's account. For example, the travel service provider may match the amounts that have been withheld from an employee's paychecks and that have been transferred to the travel provider. That is, the travel service provider may deposit funds into the employee's account using the corresponding identification numbers. In reality, the travel service provider need not actually deposit funds to each employee's account, but may instead “match” the employee's contribution by creating a “credit” or other indication that the amount of overall funds an employee has to purchase travel is increasing. The travel service provider may contribute to the employee's account until its share of the covered amount has been met.

The aspect of the present invention regarding the matching of funds may also involve the employer. That is, the employer may also contribute funds to the employee's account at the travel service provider in order to satisfy its obligation to contribute to the covered amount. If an employee's employment ceases, through severance, resignation or otherwise, the travel service provider may keep, reimburse or credit the employee's contributions and/or benefit according to the program's terms. These terms may also be agreed upon by the employer and travel service provider during the assess step of FIG. 1.

8) Purchase Travel Airfares (Employee)

Another aspect of the present invention involves an employee's purchase of travel. At any point during the plan year, e.g., the calendar year, the employee may access his or her benefit account and purchase travel through predetermined designated sales channels, which may include electronic media such as smartphone applications or websites, or by telephone or in-person. In a preferred embodiment, the employee may apply all or part of the funds accrued or to be accrued to purchase travel at any time during the plan year. If the cost of desired travel exceeds the covered amount, the employee must pay the excess amount out of pocket. However, the employee would still be benefiting, and in effect receiving discounted travel, because he or she would have received the amount of the difference between the employee's contribution and covered amount for free. In a preferred embodiment, purchase of the travel is required during the plan year; however, travel is not required to be completed during the plan year, subject to the travel provider's policies. In a preferred embodiment, any unused amount remaining in the employee's benefit account with the travel provider at the end of the plan year may be forfeited to the airline and/or employer (depending on the terms of the program as agreed upon between them).

9) Complete Travel (Employee)

The employee and/or any covered dependents may then complete air travel on fares purchased through the program, which may be subject to applicable rules.

Thus, according to this embodiment of the present invention, employees may obtain a certain amount available to spend during the plan period on travel through the program (covered amount), in exchange for contributing a lesser amount during the plan period (withheld or contribution amount), the difference between the two amounts being borne by the airline and/or employer.

Consequently, the employer is provided an added benefit with which to enhance its compensation programs, with cost to the employer being limited to its realized benefit contribution and the costs of administering the plan.

For its part, the travel service provider gains a way to grow the size, captivity, and loyalty of its customer base, and it may gain the following new revenue streams (the first two of which, depending upon the agreement reached, may be shared with the employer): (i) amounts forfeited by employees who purchase less than the covered amount during the plan period; (ii) increased working capital and interest obtained from aggregate employee and employer contributions held in reserve; (iii) excess revenue from airfare purchases above the covered amount; and (iv) option to generate more revenue through hybrid programs.

The systems that may be used to implement the method of the current invention are now described in more detail. In a preferred embodiment, the system of the current invention may include one or more databases that are maintained by the travel service provider and/or employer. These databases may comprise relational databases so that a change, for example, in the information contained in an airline database may make a corresponding change in the employer's database and vice versa.

For example, the travel service provider, such as an airline, may maintain a database in which a unique identification number is assigned to each of the employer's employees who are participating in the travel benefit program. This database may be initially populated by the employer providing the names of the participating employees who have opted into the program. The airline may then assign a unique identification number or other reference to each employee. This database may be linked to a database maintained by the employer, such as a database in the human resources department of the employer.

These databases may serve various functions. For example, after the databases are initially established, they may then be used to track various information associated with the travel benefit program. For example, as an employee has a certain amount of his or her compensation withheld each month, information reflecting how much has been withheld in a given month, how much has been withheld cumulatively to date, and how much is intended to be withheld for the entire plan period may be stored in the employer database. Because the airline database may be connected thereto, the airline may also possess this information. This may automatically allow the airline to assess what discount, if any, it may need to provide when the employee purchases an airfare.

For example, when it comes time for an employee to purchase a ticket, the system may keep track of the covered amount that applies to that particular employee. In this manner, if an employee purchases a ticket that exceeds the covered amount, the airline may automatically know how much to charge that employee above the covered amount. The airline will also know that its full contribution to the covered amount will need to be made.

The system may also keep track of when the employee completes travel. The system may also keep track of what destinations that the employee(s) travel to. This system may be used to market specific travel to the employer and/or those employees.

Similarly, the connectedness between the employer and airline databases may keep track of each employee's status with respect to the travel benefit plan. For example, the employer, and thus the airline, may keep track of whether the employee has opted in, opted out or is perhaps no longer an employee. In the latter two situations, where the employee cannot be a participant, the airline would know not to provide any benefit of the program if that individual attempted to purchase a ticket as a participating employee. This may be important to provide a security benefit.

Based on the information in the above-described databases, any number of reports may be generated to track how the program is actually being used by employees. For example, reports may be generated indicating the number of employees who travel based on the program, the number of times the full covered amount is used, the number of times the full covered amount is not used which may also involve amounts to be kept by the employer and travel service provider, etc. These reports preferably advise the travel service provider and employer how well the program is working.

The system of the current invention preferably provides the participating employee with the ability to access the system through a smart phone or other device. That is, participating employees may preferably log-on to the system to check their “travel account” which may include such information as their monthly withholding, cumulative amount withheld and/or the covered amount applicable to them. In a preferred embodiment, the employee may also access the covered amount and purchase an airline ticket.

The system of the current invention may also keep track of all airfare purchased by a particular employer's employees. Based on this information, the airline may offer discounts to the employer for business travel.

While the embodiment described herein provides the example of a travel service provider, the method of the present invention could alternately or additionally—to travel services—be applied to the provision of various other items of commerce such as: other travel-related services like lodging; other non-travel related services such as dining, life insurance, pre-paid legal services, et cetera; and even goods such as consumer or other products (e.g., with a dominant national ‘superstore’ being a partnered provider).

Another embodiment of the present invention may comprise an employee benefits program that may not require the employee to contribute their own funds to the program in the form of withheld earnings from their paychecks, through direct deposits or through other means of contribution. In this case, when the employee purchases a service or goods from a provider, such as travel from a travel service provider, the funds contributed by the provider and the employer may be applied to the purchase, and the employee may only become responsible for the amount remaining due for the service at the time of purchase. In this manner, the employee need not make any contribution until the purchase of the service actually occurs.

For example, if the employer and the airline each contribute $250 during the program period and these funds are fully vested at the time the employee wishes to purchase an airline ticket, and the original cost of the airline ticket is $800, the $500 contributed by the employer and the airline may be applied to the $800 cost of the airline ticket thus reducing the cost to the employee to $300. The employee may then be required to pay the $300 due in order to purchase the airline ticket. In this example, the employee benefits since his or her take home pay is not reduced by the amount of funds that would be withheld as described above.

In another embodiment, the employee benefits program may be established such that some or all of any unused portion of the employee's contribution through withheld compensation, direct deposits or other contribution means may roll-over to the next program period with little or no penalty if the employee's contributions were not fully used during the current period. In this case, a predetermined percentage or a specific portion of the withholdings may roll-over accordingly, or the amount of employee contributions that may roll over may be calculated by a moving window or other means.

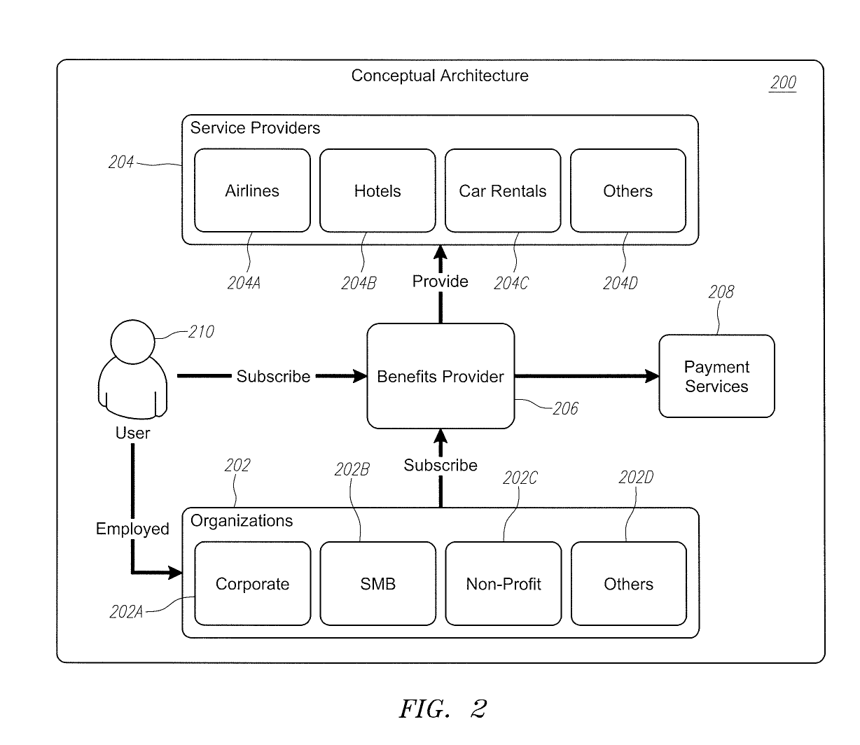

Another embodiment of the present invention is now described with reference to FIGS. 2-5 which depict benefits program or system 200. As shown, system 200 may involve several participants, such as employer or other type of organization 202, providers 204, benefits provider 206 and user 210 such as an employee or other individual. System or benefits program 200 may also involve a payment services entity 208 which may be a bank or which may be part of benefits provider 206. The relationships and interaction between each of these participants in system 200 may be configured as shown in FIG. 2, though other system architectures may be used.

It should be noted that organization 202 may comprise a typical company employer such as corporation 202A. However, organization 202 may comprise other types of entities such as SMB 202B, non-profit organization 202C or other entity type 202D. Accordingly, the scope of the present invention is not limited to “employers” in the traditional sense of the word. Rather, any entity seeking to provide a benefit is included within the scope of the invention.

Similarly, user 210 may comprise an employee or other type of individual or user of system 200. Accordingly, the scope of the present invention is not limited to “employees” in the traditional sense of the word, nor is the present invention limited employer/employee relationships. Rather, the present invention includes any relationship where individual 210 is somehow associated with organization 202 and/or uses system 200.

Similarly, various types of providers 204 may be involved in system 200. To this end, provider 204 may comprise service providers such as airlines 204A, hotels 204B and car rentals 204C. However, provider 204 may also include other entities 204D that may be retailers or wholesalers of goods. Accordingly, the scope of the present invention is not limited to service providers such as airlines 204A.

In sum, the use of the terms employee, employer and service provider does not limit the scope of the invention. Instead, the current invention includes the various entities and individuals described herein as well as others.

The relationships between the participants of system 200 are now further described. As shown in FIG. 2, employer 202 and service provider 204 may not have a direct relationship with each other. Instead, each may enter into a relationship or otherwise directly interface with benefits provider 206. In this manner, benefits provider 206 may serve as a link between employer 202 and provider 204 for benefits program 200 to operate and provide benefits to user 210. That organization 202 and provider 204 deal with benefits provider 206 instead of with each other may provide advantages as discussed later.

Organization 202 may subscribe to benefits provider 206 and pay a subscription fee thereto. The subscription fee may be a flat fee, a percentage of the benefits arranged by benefits provider 206 or some other type of payment. In any event, this subscription relationship preferably represents a revenue stream to benefits provider 206. Other types of relationships between organizations 202 and benefits provider 206 may also be used.

The relationship between providers 204 and benefits provider 206 may resemble that of contracting parties. To this end, providers 204 and benefits provider 206 may negotiate the terms on which the provider's goods or services will be made available in program 200. Thereafter, benefits provider 206 may arrange for the providers' goods or services to be bought by users 210. As discussed above, participation in system 200 is preferably advantageous to providers 204 since users 210 may represent a previously untapped customer base. In exchange, providers 204 generally provide their goods or services at a discounted rate (for example, by contributing some of the covered amount). Providers 204 may also pay a fee to benefits provider 206 in order to participate in system or program 200.

Users 210 may be subscribers to benefits provider 206 and may generally be associated with organization 202, such as by employment. The subscription of users 210 to benefits provider 206 may involve some type of financial contribution similar to that discussed above in connection with an employee's contributions to his or her employer. For example, where user 210 is an employee of organization 202, the user's subscription may comprise a certain amount of money withheld from the employee's paychecks as discussed above that is delivered to benefits provider. In another alternative, however, it may be that user 210 need not contribute any money for this subscription.

As discussed later, benefits provider 206 may also interface with a payment services entity 208. The entity providing payment services 208 may be part of benefits provider 206 or may represent a separate entity, such a bank, with which provider 206 interacts. In one embodiment, the payment services entity 208 may hold the money contributed by users 210 until a provider's services or goods are purchased, at which time the money may be transferred to the provider. Alternatively, benefits provider 206 may perform these functions itself.

The functions of benefits provider 206 are now further described. As an initial matter, the positioning of benefits provider 206 in an intermediary role may provide administrative benefits to organization 202 and/or provider 204. That is, benefits provider 206 may be better positioned and have more experience to implement the benefits program 200 than organization 202 and/or providers 204. In other words, benefits provider 206 may function as an efficient outsourced service.

In a preferred embodiment, benefits provider 206 may become well known in relevant markets. For example, a benefits provider 206 named BLUE SKIES may come to be known as providing discounted airline fares. In this case, potential employees 210 of an employer 202 may come to ask whether the employer 202 offers the BLUE SKIES benefit. This may provide morale and recruiting benefits to organization 202 as discussed above.

Furthermore, benefits provider 206 may interface with a number of providers 204, so that the users 210 associated with a particular organization 202 may receive benefits involving various goods and services as opposed to just one. This enhancement of program 200 does not require organization 202 to deal with a number of providers 204. Instead, organization may generally deal only with a single entity, i.e., benefits provider 206 which coordinates providers 204 and users 210. This may save considerable administrative time and expense for organization 202.

Benefits provider 206 may also provide value-added services to organizations 202 and/or providers 204 beyond the service of arranging the actual benefit itself. For example, benefits provider 206 may consult with organizations 202 and/or providers 204 to develop the benefit plan 200 in the first place. Benefits provider 206 may also market that plan to employees or other users 210, manage the plan 200 over time and collect data on how the plan is working so that improvements may be made in the future.

Accordingly, the role of benefits provider 206 in program 200 may include: 1) working with organizations 202 to develop benefit plans that will be offered to employees or other users 210 associated with those organizations 202; 2) working with providers 204 to develop the various discount programs to be offered to users 210; 3) presenting the discount programs from providers 204 to the organizations 202 and users 210; 4) gathering feedback from organizations 202 and users 210 regarding the various benefit programs and providing this feedback to providers 204; 5) arranging agreements between organizations 202 and providers 204 to implement programs 200; 6) arranging any agreements that may be necessary with users 210; 7) collecting and managing data and information from organizations 202, users 210 and providers 204 that may be required for programs 200; 8) collecting and managing money or credits that may be contributed to program 200 by organizations 202, users 210 and providers 204; 9) managing withdrawals from the program account and subsequent payments to organizations 202, users 210 and providers 204, 10) managing transactional data that may take place as the various participants participate in programs 200, including money contributed and accumulated, money spent on services and other data; 11) interacting with a payment services entity 208 to handle funds contributed to program 200; 12) performing other tasks that may be necessary to facilitate, manage and otherwise run the various benefits programs 200; and 13) reporting on the foregoing to the participants. Benefits provider 206 may perform yet additional tasks as well.

As with prior embodiments of the present invention described above, the terms of benefits program 200 and of the relationships between the participants may first be determined. As mentioned, above, however, with use of an intermediary benefits provider 206, an organization 202 need not negotiate with multiple providers 204. And after program 200 is developed and implemented, organization 200 need not interface with its employees or other individuals who are users 210 of system 200. Instead, benefits provider 206 may handle these functions. However, it is preferred that organization may still interface with users 210 and providers 204 as need be.

As described with the prior embodiments, program 200 may include various terms such as (1) a covered amount for each user 210, (2) the proportional contribution by each of organization 202 and provider 204 to the covered amount, (3) the program or plan period, i.e., the amount of time after which the covered amount vests so that it is available to the employee (4) the manner in which user 210 contributes, e.g., withholding a certain amount from paychecks, (5) the manner in which unused user contributions are disposed of and (6) various other terms as discussed above or otherwise. These terms and any other terms that are necessary to set up and implement benefit program 200 may be determined between providers 204 and benefits provider 206, and between organization 202 and the benefits provider 206.

In one example, the terms of program 200 may provide that (i) employee 210 contributes money to his or her benefit account that may be established by benefit provider 206; (ii) employer 202 matches the employee's contribution based on either (a) a flat rate regardless of what employee 210 contributes or (b) a percentage, e.g., 5%, of what employee 210 contributes, and (iii) the employer's contribution is vested at the end a plan or program period comprising twelve months.

So where the employer matches 5% of the employee's contribution, the employee may contribute $600 over the course of the plan year at a rate of $50 per month. In that case, the employer would match $30 at the end of the plan year, for a total of $630 that would be available for use in the purchase of air travel of other goods or services through program 200.

As mentioned above, benefits provider 206 may provide value-added services to providers 204. This may include assisting in the development of discount programs for the provider's goods or services that will attract organizations 202 and users 210. Benefits provider 206 may have insight to developing such programs based on past experience and may offer this service to providers 204 in order to maximize the success of their participation in system 200. For example, benefits provider 206 may have information regarding the types of discount programs that have succeeded and failed. Benefits provider 206 may also have insight into the types of programs its member organizations 202 and users 210 want. Benefits provider 206 may offer this service at an additional cost or as part of an overall participation package.

After benefits provider 206 has helped develop a discount program for provider 204, it may prepare presentations or brochures to present the discount program to organizations 202 and users 210. Benefits provider 206 may also offer providers 204 different levels of exposure to organizations 202 and users 210 for different fee levels. Benefits provider 206 may also offer exclusivity for a fee so that a provider 204 will be the only provider of a particular good or service that may participate in program 200.

Benefits provider 206 may also help organizations 202 find the best discount offers and terms depending on their needs based on the providers 204 participating in program 200. For example, an employer organization 202 may have needs for specific goods or services depending on its size, workforce demographic, industry, etc. In order to make program 200 as attractive as possible to the employer's employees 210, benefits provider 206 may collect information from employer 202 and provide it directly to particular service providers 206 participating in program 200 that provide goods or services which correspond to the needs of the employer's employees.

Benefits provider 206 may also help users 210. For example, different users 210 may have different needs, and benefits provider 206 may provide a conduit for users 210 to provide feedback to the employers or other organizations with which they are associated and service providers 204 regarding which programs they are interested in and what types of offers they may desire in the future.

As discussed with the prior embodiment, the benefits program 200 may be marketed and presented to employees or other users 210 so as to boost the morale and productivity of the entire workforce. Program 200 may also be used as a recruiting tool with potential hires. To this end, benefits provider 206 may provide expertise to employers and other organization 202 about how to best present benefits packages to employees and other individuals. To this end, benefits provider 206 may provide advertising and marketing services directly to employees 210 through the use of brochures, fliers or electronic advertising in order to assist employer 202 attract as many employee subscribers 210 as possible. This may be another value-added service provided by benefits provider 206.

Once the terms governing how a particular benefits program 200 will operate are determined amongst all pertinent participants, benefits provider 206 may provide the necessary documents and agreements to all participants so that organizations 202, providers 204 and users 210 may participate. Once the suitable agreements are in place, benefits provider 206 may implement and manage programs 200.

It should be noted that user 210 may subscribe to a particular program 200 directly through benefits provider 206 as shown in FIG. 2. Alternatively, user may subscribe through his or her employer or other organization 202. In addition, employee or user 210 may subscribe to multiple programs 200 that benefits provider 206 may offer through the user's employer or organization 202. Also, the programs 200 offered by a particular organization 202 through services provider 206, or through itself, may include one provider 204 or a number of providers.

The implementation and running of benefit plan 200 is now further described. To help implement program 200, benefits provider 206 may collect and manage data that is generated by the enrollment of users 210. As discussed with prior embodiments of the present invention, as users enroll, data may be harvested about which programs and provider(s) they are most interested in, the desired contribution/plan amount for each program, the length of the participation period and other data that may be necessary to complete the enrollment of the employees 210 into the benefits programs. In this manner, an organization 202 may offer different programs 200 for user's seeking different plan terms.

During the enrollment process, benefits provider 206 may assign each participating user 210 a unique identification number as discuss above. This number may be used to help track user contributions. This number may also be used to establish individual user accounts at various providers that will aid in the user's purchase of goods and services.

After the initial enrollment and when program 200 proceeds, benefits provider 206 may begin to collect and manage any money and/or credits contributed to each program 200 by users 210, organizations 202 and services providers 204 according to the agreed upon program terms. The money and credits may be maintained by benefits provider 206. Alternatively, a bank or other payment services entity may hold the funds.

As program 200 proceeds, benefits provider 206 may manage withdrawals from individual user accounts that are applied towards the purchase of discounted goods or services. For example, when a user wants to purchase a discounted good or service, benefits provider 206 may withdraw money from that user's account and transfer it to the appropriate provider 204, who may then provide the discount service to user 210. Benefits provider 206 may track the amounts of money contributed by each user, each employer 202 and each provider 204. Benefits provider may also track to which program the contributed money is applied where user 210 is subscribed to more than one program with benefits provider 206.

In one embodiment, benefits provider 206 may have the ability to safely and legally hold any money contributed to any program 200 in an internal approved account. Alternatively, benefits provider 206 may have a relationship with a payment services provider 208, such as a bank, as shown in FIG. 2. In this scenario, payment services entity 208 may be used to safely and legally hold the money contributed to program 200 within an approved account such that benefits provider 206 may have the necessary access to the account to adequately manage program 200. To this end, benefits provider 206 may act like a bank customer with the ability to deposit, withdraw and transfer money.

As programs 200 are used and money is contributed and withdrawn to purchase discount goods or services, benefits provider 206 may track transactional data so that the programs are properly managed and transactions accounted for. Benefits provider 206 may also provide reports to providers 204 and organizations 202 to track program usage, program funding and other elements of each program 200. These reports may allow the participants to evaluate a program's success and to fine tune the program in the future. The system to accomplish these tasks is described later.

Benefits of involving an intermediary benefits provider in system or plan 200 are now further described. One advantage is that benefits provider 206 may be able to more easily establish relationships with multiple providers 206 and organizations 202—than would an individual organization 202 or provider 204—to provide a larger pool of goods and services available to an organization's users 210, and to provide a larger potential customer base for providers 204.

Another benefit pertains to the transferability of a user's account with benefits provider 206. To this end, benefits provider 206 may be involved with various organizations 202. Where the user 210 is an employee, and where the employee wishes to employment of one employer 202 to another, if both employers 202 have benefit program relationships with benefits provider 206, employee 210 is preferably permitted to port his or her account from the first employer to the next.

Certain restrictions may apply on such transfers however. For example, depending on the program terms at the first employer 202, employee 210 who wishes to port his or her account to another participating employer 202 may or may not be able to transfer the entire amount invested in the account. For example, employee 210 may be able to transfer only that money he or she has personally contributed to the program, but not any money from the first employer that is not yet vested according to the vesting terms of the program.

As another example, employee 210 may or may not be penalized for exiting a particular benefits program 200 early if he or she no longer desires or is unable to continue participating. The penalty may be in the form of an early withdrawal flat fee, a fee based on the percentage of the money contributed or owed to the account, or some other type of fee or charge.

The manner in which benefits provider 206 is compensated and its revenue streams are now further described. For example, benefits provider 206 may receive a percentage of funds contributed to programs 200 by users 210, organizations 202 and/or providers 204. Alternatively, benefits provider 206 may receive a percentage of the money spent by users 210 when buying goods or services. Alternatively, benefits provider 206 may charge a flat fee to each participating organization, or a menu of various fees charged to the various participant organizations depending on the level of their participation. In addition, benefits provider 206 may charge additional fees for any value-added services they provide to the participating organizations depending on what services are provided. Benefits provider 206 may also charge a combination of the types of compensation models described above, or may charge other fees and charges during the development and operation of benefits programs 200.

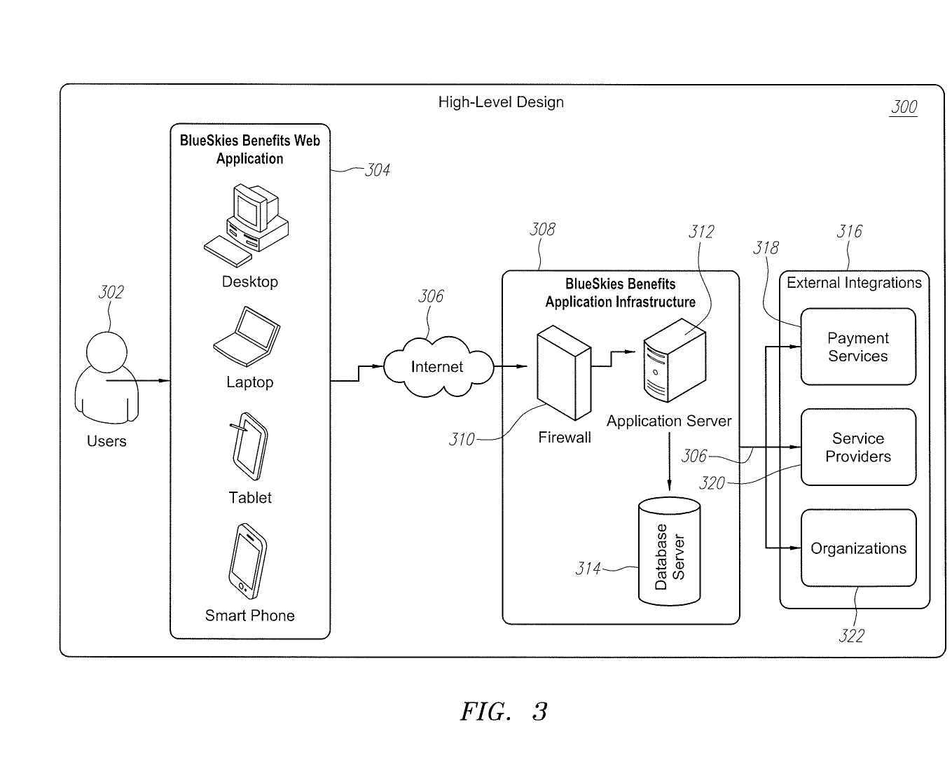

The systems 300 that may be used to implement system 200 are now described with respect to FIG. 3. As depicted, system 300 may embody a system architecture 300 comprising an Internet or network accessible device 304, the Internet or other network 306, the benefits provider application infrastructure 308, and external integrations and applications 316. In general, system 300 may connect and provide users 302 with access through the Internet or other network 306 to the benefits provider's application infrastructure 308 as well as potentially to other external integrations 316.

Different users 302 may be granted access to application infrastructure 308. For example, user 302 may be an employee 302 who is participating in the employee benefits program that is hosted on the benefit provider's application infrastructure 308, or the user 302 may be a member 302 of the benefit provider's team who may manage or otherwise work with the benefits provider to help operate the employee benefits program. Additionally, user 302 may be another person who requires access to the benefits provider's application infrastructure.

In one example, an employee 302 who participates in a benefits program may wish to access the benefits provider's application infrastructure 308 to acquire information on his or her account such as contribution amounts made during the benefits vesting period, current balances in the account and purchase history. The employee user 302 may also wish to access their account within the application infrastructure 308 in order to purchase discount services from a provider participating in the program such as air travel tickets or some other goods or services.

User 302 may be able to access his or her account by providing an identification number that was assigned to him or her upon enrollment or at some other time during the program. A password may also be associated with that identification number to provide security. This may be the same identification number discussed previously which may also be used to purchase goods or services, and which may enable system 300 to track transactions per user 302.

In another example, a user member 302 of the benefits provider team may require access to the application infrastructure 308 in order to manage or otherwise work on the hardware, software or other components of system 308. In addition, member 302 of the benefits provider team may also need access to system 300 to update files and data that may be required to manage, develop or otherwise work on a particular benefits program.

It should be noted that each user 302 may have different log-in credentials and different levels of access to the system 308. Depending on which type of user 302 the person is, they may be able to access different types of data and files within the system 308 as necessary. For example, an employee 302 may only be able to access information regarding their individual personal account within the system 308. However, a member 302 of the benefits provider team may be able to access information regarding the operating system and software components that make up the applications infrastructure 308. In addition, a system manager 302 for instance may be able to access information regarding an individual's account while helping them with their terms or otherwise providing them customer support.

The system architecture 300 may be designed and constructed to allow a user 302 to access the benefits provider's system 308 through the Internet or other type of network 306 using an Internet or network accessible device 304 such as a desktop computer, a laptop computer, a tablet computer, a smartphone or any other device that may allow the necessary access to the Internet or other network 306. Such Internet or network accessible devices 304 are also referenced as communication devices 304 herein. Details regarding how the user 302 may interact with the system 308 using web applications, webpages, user interfaces or other means will be described in later sections below.

As shown in FIG. 3, the benefits provider application infrastructure 308 may comprise of a firewall 310, an application server 312 and a database server 314 as well as other suitable components not shown.

The firewall 310 may provide security to the system 308 and may prevent unauthorized access to the system 308.

The application server 312 may contain the operating system and any other software, scripts and other data files necessary to manage all of the data and information discussed above that the benefits provider may be responsible for during its development, management, support and facilitation of the benefits program. For example, the applications server 312 may include website files that the server 312 may display to a user 302 that may allow the user 302 to interact with the system 308. The applications server 312 may also include software that allows the user 308 to access and interact with data that may be stored in the database server 314. In addition, the applications server 312 may include software that allows the system 308 to interact with the external integrations 316 as shown in FIG. 3. In general, the applications server 312 may include all of the necessary hardware, software and other data files necessary to develop, facilitate and otherwise operate the benefit program in its entirety and to allow users 302 to access any data necessary during this operation.

As described with the prior embodiments of the current invention, the data within the applications infrastructure 308 that may relate to the program and the individual employee accounts may be contained within relational databases, and these databases may be contained within a database server 314. The database server 314 may contain software necessary to manage the relational databases, and these databases may in turn be accessed through the applications server 312 as described above. In addition, the applications server 312 may itself contain software necessary to manage the relational databases held within the database server 314.

It should be noted that the benefits provider's application infrastructure 308 may also include additional servers and data storage units as well as other hardware necessary for the development, management and general operation of the employee benefits programs. In addition, the hardware, software and data that may make up the overall application infrastructure 308 may be hosted within the benefits providers own facility, or may be hosted or co-hosted by a third party outside the benefits provider entity. Also, the benefits provider may host some of the components of the application infrastructure 308 while other components are hosted or co-hosted by third parties as necessary. Third party providers may also be involved in the development, management and overall operation of the benefits programs.

As shown in FIG. 3, the benefits provider's application infrastructure 308 may access and interact with external applications and integrations 316 through the Internet or other network 306 that may reside on other external servers as necessary. These external applications and integrations 316 may include firewalls, application servers, database servers that may contain relational databases, and other components.

Examples of external applications and integrations 316 that the benefits provider's application infrastructure 308 may gain access to and interact with may include the payment service's applications 318, as well as provider applications 320 and organization applications 322 for those providers 204 and organizations 202 that participate in program 200.

As described above in relation to FIG. 2, benefits provider 206 may have relationships with organizations 202, users 210 and providers 204 while managing benefits programs 200 in which these entities participate. Accordingly, benefits provider 206 may require access to particular applications that each of these entities may have in order to manage programs 200.

For example, benefits provider 206 may require access to the payment service's applications 318 (FIG. 3) where information regarding the various user 302 accounts may be hosted. Benefits provider 206 may need access to these accounts to deposit, withdraw and transfer money into or from particular accounts, to determine account balances and for other reasons. These accounts may be tied to the particular identification number associated with a particular user 302.

In another example, benefits provider 206 may require access to the provider's applications 320 in order to purchase benefit services from provider 206 on behalf of user 210, or in order to deposit money into the provider's account to pay for such purchased services. Benefits provider 206 may also require access to the service provider's application 320 for other reasons necessary to operate the benefits program.

In addition, benefits provider 206 may require access to the organization's applications 322 in order to authenticate users associated with that organization, to provide access according to a user's particular authorization level, to identify which benefits programs the user may belong to, to access user data necessary for the operation of the programs and for other reasons.

As described with prior embodiments above, data pertaining to program 200 may be contained in relational databases within the benefits provider's application infrastructure 308, and in relational databases within the external applications and integrations 316, and these various relational databases may be connected together through the Internet or other network 306. This way, changes made to one database may cause similar changes to be made in the appropriate places within the other relational databases that may be connected to it, thereby updating all of the databases when changes are made

It should be noted that these external applications and integrations 316 may also be hosted, co-hosted or supported inside the benefits provider's architecture 308 and the benefits provider may offer these hosting services as value-added services. In this scenario, the benefits provider may be able to directly access the additional applications and systems within its internal system.

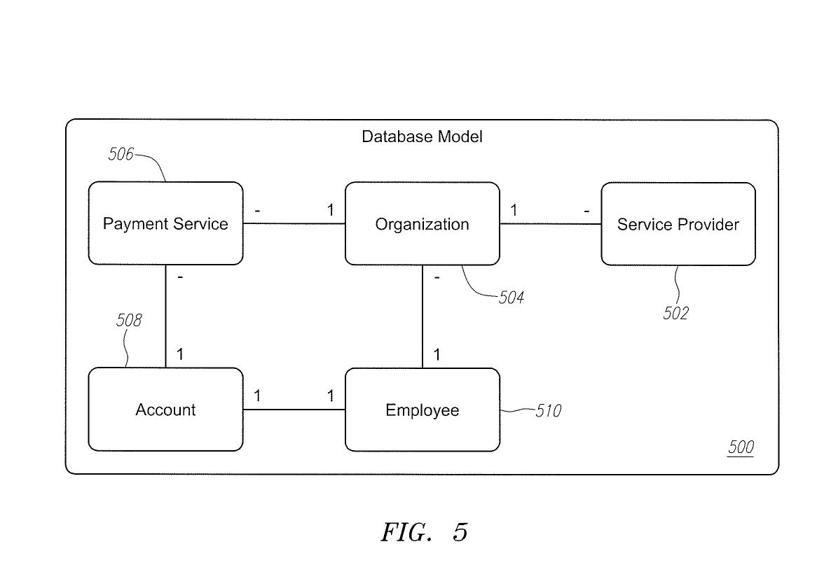

Referring now to FIG. 5, a high-level database model 500 that may reside in the database server 314 of the benefits provider's application infrastructure 308 in FIG. 3 is now described. It should be noted that some of the components of the database model 500 may also simultaneously exist within appropriate external applications and integrations 316 of FIG. 3 as described below.

The overall database structure 500 that may contain all or some of the data necessary for the benefits provider 206 to develop, facilitate, manage, operate and maintain benefits programs 200 may include the following individual relational databases: 1) the service provider database 502 which may contain data regarding the service provider and the offers that it is providing to the program, 2) the organization database 504 which may contain data regarding the organization and the programs in which that organization may be participate, 3) the payment services database 506 which may contain information regarding the payment service provider, 4) the account database 508 which may contain information regarding the employee accounts within the programs, and 5) the user database 510 which may contain data regarding the user's profile, the programs in which the user participates and the setting for each program. Other data not listed above may also be included in the databases as necessary. Other databases not shown may also be included.

Referring back to FIG. 3, the relational databases that may reside within the external integrations and applications 316, and the manner in which these databases may relate to and be linked to the database structure depicted in FIG. 5, are now further described. For example, the service provider external applications 320 may include a relational service provider database (not shown) that may be linked to the relational provider database 502 of FIG. 5 within the benefits provider's database model 500. Accordingly, when the service provider organization makes a change to the service provider database within its external applications 320, the change may be automatically made and reflected in the provider database 502 in FIG. 5. In addition, the organization external applications 322 may include a relational organization database (not shown) that may be linked to the relational organization database 504 of FIG. 5 within the benefits provider's database model 500 such that changes made in the organization database within the organization external applications 322 may be automatically made and reflected in the organization database 504 of the FIG. 5.

It should be noted that the opposite may also be true, and that changes made to the relational databases contained within the benefits provider's database model 500 of FIG. 5 may also be made to the relational databases that may reside in the external integrations and applications 316 of FIG. 3.

Returning to FIG. 5, it bears note that the provider database 502 is linked to the organization database 504. Accordingly, a change that may be made to the provider database 502 may also be made to the organization database 504. Therefore, looking at the system as a whole and including both the relational databases that may be included within the benefits provider's database model 500 of FIG. 5 and the relational databases that may be included in the external integrations and applications 316 of FIG. 3, changes made to any relational databases that may be linked together may be automatically made to the others.

For instance, in the example above, a change that may be made to the provider relational database (not shown) that may reside in the provider's external applications 320 in FIG. 3 may also be automatically made to the provider relational database 502 and the organization relational database 504 in FIG. 5, and to the organization database (not shown) that may reside in the organization external applications 322 of FIG. 3. Thus, if the provider uploads data regarding a new benefits program discount offer to its database, this data may automatically be uploaded to the appropriate databases within the benefits providers database structure 500 of FIG. 5 as well as to the organization database within the organization external applications 322 of FIG. 3 such that all parties participating in the benefits program may immediately be aware of the new offer.

It should be noted that depending on the programming and structure of the linked relational databases involved, not all data that is updated on one relational database may be updated on the others. For instance, while data pertaining to new provider offers as shown in the example above may be appropriate to share between the linked databases, private account information that may be updated within the organization database may not be appropriate to share with the provider database. Also, data between the databases may be linked by a unique identifier such as an account number, a log-in ID, an entity name, a password or other unique identifier as necessary.

Returning to FIG. 5, various possible links and relationships between the various databases that may be included in the benefits provider's database model 500 is shown. Using the example described above regarding the provider database 502 and the organization database 504, it can be seen that changes made to the other relational databases within the model 500, and changes made to other relational databases that may reside in the external applications 316 of FIG. 3, may result in appropriate changes also made within the other linked relational databases.

While FIG. 5 depicts the databases and relationships as shown, other databases and other relationships may be used.

To access the benefits provider's application infrastructure 308, a user 302 may use a communication device 304 to visit a webpage or website, a web application or other user interface that may be hosted on or otherwise connected to the application infrastructure 308 through the Internet or other network 306. The various means that may be used to access the application infrastructure 308 are generally referenced herein as webpages, but these means may be web applications or other user interfaces that allow access to the system 308.

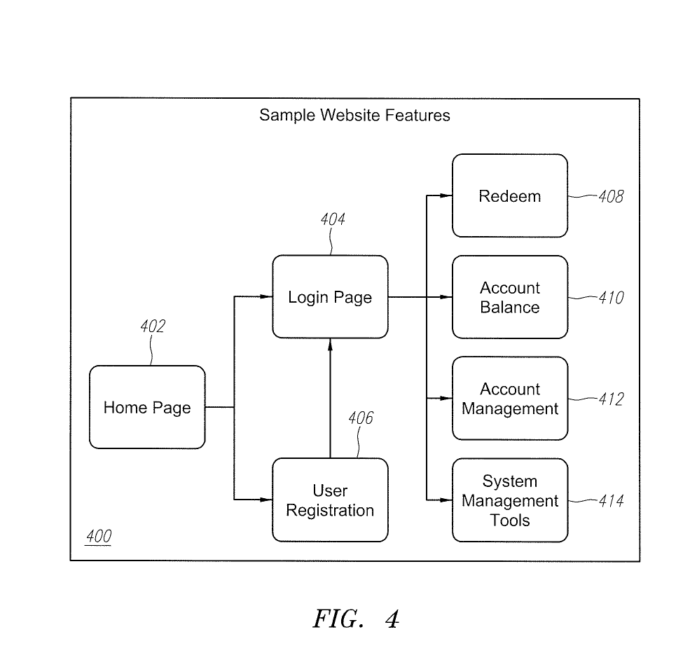

System website features 400 that may allow a user 302 to log onto or otherwise access and interact with the application infrastructure 308 are depicted in FIG. 4. As shown, the system website features 400 may include a homepage 402, a log-in webpage 404, a user registration webpage 406, a redeem webpage 408, an account balance webpage 410, an account management 412 webpage, a system management tools webpage 414, and other webpages that may not be shown.

To gain access to the system website features 400, the user 302 may use a communication device 304 as depicted in FIG. 3. Such communication devices 304 may utilize an Internet browser, a device app, an Internet app or widget, or some other type of network application that may allow them to access the system 308.

Referring back to FIG. 4, the homepage 402 may introduce the benefits program and the various participating entities that are involved with the program. The homepage 402 may act as a marketing vehicle to introduce and educate the viewer to the benefits of the program. Other information regarding the program such as the general legal terms, disclaimers and other necessary information may also be displayed.

The homepage 402 may include a link that leads to the log-in page 404, or the log-in page 404 may be integrated directly into the homepage 402. The log-in page 404 may allow the user to enter their log-in credentials to gain access to other areas of the website. These log-in credentials may include a user ID, a password and other identifying data, such as the identification number associated with a particular user as described above, that the user may need to enter.

If the user does not have these log-in credentials, they may instead visit the registration page 406 that may be either integrated into the homepage 402 or the log-in page 404, or may be a separate webpage that may be accessed through a link on the homepage 402 or log-in page 404. The registration page 406 may ask the user to enter in a variety of information regarding their profile, their employer and the benefits accounts they wish to participate in. Once this information is entered, the system may create a unique user account for the new user and present them their log-in credentials necessary to log into the system using the log-in page 404. Conversely, the user may be able to choose the user ID and password they wish to use to log onto the system and the system may store this along with the other necessary information for the new user account.

Once the user is logged into the system, they may have access to the redeem webpage 408, the account balance webpage 410, the account management webpage 412, the system management tools webpage 414 as well as other webpages on the website depending on their access level.

The redeem webpage 408 may allow the user to purchase services from the various service providers participating in the employee benefits program. The user may redeem all or a portion of their credits or cash balances within their account to purchase the services. Once the services are purchased, the cash or credits may be transferred to the service provider, and the purchased service may be transferred to the user's account by means of the service provider's external integration and applications 316 as described above and depicted in FIG. 3. This process may involve the benefits provider's application infrastructure 308 accessing and interacting with the payment service's external applications 318 in order to withdraw money from the user's 302 account, then accessing the service provider's external applications 320 to deposit the money into the service providers account and receive the service being purchased, and then accessing the employer's external application 322 to update the user's account settings to reflect the purchase of the service from the service provider along with the means for the user to receive the service.

The account balance webpage 410 may reflect the current status of the user's accounts and may show information such as the amount of cash or credits that are currently being held and available within the account, the amount of cash or credits that have been contributed by the employer, the employee and the services provider, the amount of cash or credits that are scheduled to be contributed to the account by the end of the program period, the amount of cash or credits that have been redeemed for services by the employee, and other information that may be useful to the user regarding their benefits program account. In order for the account balances webpage 410 to reflect this type of account information, it may be necessary for the benefits provider's application infrastructure 308 as shown in FIG. 3 to access and interact with the payment provider's external applications 318, and then to display the information received from the payment provider to the user 302.

The account management webpage 412 may reflect the profile and various identifying information regarding the user such as their name, address, employer, bank account information and other information. This account management webpage 412 may allow the user to update or edit some of this information in order to keep it current. In addition, various settings regarding the user's benefits programs may also be reflected by this webpage 412 and edited by the user. Such settings may include the amount of money that the employee wishes to contribute during each month or other payment period, the different programs that the employee wishes to participate in, the length of the period the employee wishes to participate for, and other settings. In order for the account balances webpage 410 to reflect this type of account information, it may be necessary for the benefits provider's application infrastructure 308 as depicted in FIG. 3 to access and interact with the payment provider's external applications 318, and then to display the information received from the payment provider to the user 302.

In addition, some of the examples described above may also involve the benefits provider application server 312 interacting and updating the appropriate relational databases within its own database server 314, and since these relational databases are linked to the relational databases that may exist in the external applications 316, information updated on the databases within the database server 314 may also be reflected in the databases within the external applications 316.

The system management tools webpage 414 may allow a member of the benefits provider team to access the system and utilize tools that may be necessary to properly set-up, maintain, troubleshoot and operate the various firewalls 310, application servers 312, database servers 314 as well as any other hardware or software that may be utilized by the benefits programs. In addition, the system management tools webpage 414 may also allow a member of the benefits provider team to properly maintain, troubleshoot and operate any benefits programs that may be hosted on the benefits provider's applications infrastructure.

It should be noted that while the above descriptions depict the user accessing the benefits provider's application infrastructure 308 of FIG. 3 by utilizing the system website features 400 of FIG. 4 whereby in turn the application infrastructure 308 may then access the external integrations and applications 316 of the service providers 318, the payment providers 320 and the employers 322, the system website features 400 of FIG. 4 may also provide the user pass-through access directly to the external integrations and applications 316 as necessary.

In general, the system website features 400 may allow an employee user to register, log-in and generally manage and actively participate in their employee benefits program accounts. It may also allow a member of the benefits provider team to properly develop, troubleshoot, operate and maintain the various employee benefits programs as well as provide customer support to the participants.

The present invention includes a number of aspects and features which may be practiced alone or in various combinations or sub-combinations, as desired. While preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. An employee benefit system, comprising:
a database for storing a covered amount provided by an employer and a service provider, wherein the covered amount is an amount contributed to the cost of a service purchased by the employee;
a system for collecting the employee's contribution towards the cost of the service; and
a system for applying the covered amount towards the purchase of the service by the employee;
wherein the employee realizes a benefit in the form of a cost reduction of the service when purchasing the service.

2. The employee benefit system of claim 1, wherein the service is a travel service.

3. The employee benefit system of claim 2, wherein the travel service is air travel.

4. The employee benefit system of claim 1, wherein the covered amount depends on the level of employee, the cost of the service or the employee's work performance.

5. The employee benefit system of claim 1, wherein the cost reduction is the difference between the covered amount and the employee contribution.

6. The employee benefit system of claim 1, wherein the system to collect the employee contribution is an automatic withholding from compensation.

7. The employee benefit system of claim 1, further comprising an employee identification number which is associated with the employee, the employee's covered amount.

8. The employee benefit system of claim 7, wherein the service provider maintains a service database that interfaces with the database based on the employee identification number.

9. The employee benefit system of claim 1, wherein the database further stores a period over which the employee's contribution must be made in order for the employee to realize the benefit of the cost reduction.

10. The employee benefit system of claim 1, wherein the system for applying the covered amount towards the purchase of the service by the employee includes a smartphone.

11. A system for providing benefits, comprising:
a benefits provider that is configured to interface with at least an organization, a provider and a user; and
a user account that is established by the benefit provider and that is configured to receive user contributions and contributions from the organization;
wherein the benefits provider is configured to arrange a purchase of services or goods from the provider using the user contributions and the contributions from the organization.

12. The system of claim 11, wherein the benefits provider is a database.

13. The system of claim 12, wherein the database includes databases for storing information about the organization and provider.

14. The system of claim 11, wherein the user is associated with the organization.

15. The system of claim 14, wherein the user is an employee of the organization.

16. The system of claim 11, wherein the account is configured to be portable from the organization to another organization.

17. The system of claim 11, wherein the at least one organization includes a corporation, an SBO or a non-profit organization.

18. The system of claim 11, wherein the provider is a service provider.

19. The system of claim 18, wherein the service provider is an airline.

20. The system of claim 11, wherein the benefits provider is configured to interface with a payment service to facilitate the purchase of services or goods.
